(19) United States
(12) Patent Application Publication
(10) Pub. No.: US 2014/0375081 A1
(43) Pub. Date: Dec. 25, 2014

(54) VEHICLE-BODY FRONT STRUCTURE

(71) Applicant: Toyota Jidosha Kabushiki Kaisha, Toyota-shi Aichi-ken (JP)

(72) Inventors: Tomoyuki Kuriyama, Toyota-shi Aichi-ken (JP); Akihiro Tamaoki, Tajimi-shi Gifu-ken (JP); Masanobu Omi, Kasugai-shi Aichi-ken (JP); Kosuke Sakakibara, Toyota-shi Aichi-ken (JP)

(21) Appl. No.: 14/302,510

(22) Filed: Jun. 12, 2014

(30) Foreign Application Priority Data
Jun. 21, 2013 (JP) 2013-130977

(51) Int. Cl. B62D 25/16; B62D 25/08

(52) U.S. Cl. CPC B62D 25/16; B62D 25/082; B62D 25/088
USPC 296/187.1

(57) ABSTRACT

A vehicle-body front structure includes a front side member and a wheel house. The front side member is arranged at a side part of the vehicle-body front portion so as to extend in a vehicle front-rearward direction, and configured such that a front wheel is arranged at an outer side of the front side member in a vehicle width direction. The wheel house covers the front wheel from an upper side in a vehicle up-down direction, and is curved along a circumferential direction of the front wheel. The wheel house includes a closed-section portion having a closed-shaped section when viewed from the vehicle front-rearward direction, the closed-section portion being formed at least in an intermediate part of the wheel house in the vehicle front-rearward direction.

### INCORPORATION BY REFERENCE

The disclosure of Japanese Patent Application No. 2013-130977 filed on Jun. 21, 2013 including the specification, drawings and abstract is incorporated herein by reference in its entirety.

### BACKGROUND OF THE INVENTION

1. Field of the Invention

The present invention relates to a vehicle-body front structure.

2. Description of Related Art

There has been known a front-portion vehicle body structure including: a front side member (a front side frame); and an upper member arranged at an outer side of the front side member, extending from a lower end part of a front pillar to a vehicle front side and a vehicle lower side, and reaching a front part of the front side member (for example, Japanese Patent Application Publication No. 2005-112173 (JP 2005-112173 A)).

In a technique described in JP 2005-112173 A, at the time of a vehicle front collision on an outer side relative to the front side member in a vehicle width direction (hereinafter, this collision state is referred to as “short overlap collision”), a collision object is received by a front end part of the upper member.

In the technique described in JP 2005-112173 A, it is possible to receive the collision object by the front end part of the upper member at the time of the short overlap collision. However, in order to improve collision performance with respect to the short overlap collision, a further solution is expected.

### SUMMARY OF THE INVENTION

The present invention provides a vehicle-body front structure that is able to improve collision performance with respect to a short overlap collision.

A vehicle-body front structure according to one aspect of the present invention includes: a front side member arranged at a side part of a vehicle-body front portion so as to extend in a vehicle front-rearward direction, and configured such that a front wheel is arranged at an outer side of the front side member in a vehicle width direction; and a wheel house covering the front wheel from an upper side in a vehicle up-down direction, curved along a circumferential direction of the front wheel, and including a closed-section portion having a closed-shaped section when viewed from the vehicle front-rearward direction, the closed-section portion being formed at least in an intermediate part of the wheel house in the vehicle front-rearward direction.

According to the vehicle-body front structure, the front wheel is arranged at the outer side of the front side member in the vehicle width direction. The front wheel is covered with the wheel house from the upper side in the vehicle up-down direction. Accordingly, at the time of a short overlap collision in which a vehicle front collision occurs at an outer side relative to the front side member in the vehicle width direction, a collision object collides with the wheel house.

Here, the wheel house is curved along the circumferential direction of the front wheel, and includes a closed-section portion formed at least in the intermediate part in the vehicle front-rearward direction. The closed-section portion has a closed-shaped section when viewed from the vehicle front-rearward direction. The closed-section portion increases a rigidity of the intermediate part of the wheel house in the vehicle front-rearward direction, thereby making it possible to transmit a collision load rearward in the vehicle front-rearward direction via the intermediate part of the wheel house at the time of the short overlap collision.

According to the vehicle-body front structure, it is possible to improve collision performance with respect to the short overlap collision.

The vehicle-body front structure may include a suspension tower arranged at the outer side of the front side member in the vehicle width direction, and configured to support an upper end part of a suspension that supports the front wheel, and at least part of the closed-section portion may be placed at a front side of the suspension tower in the vehicle front-rearward direction.

According to the vehicle-body front structure, at least part of the closed-section portion of the wheel house is placed at the front side of the suspension tower in the vehicle front-rearward direction. Accordingly, when the wheel house moves rearward in the vehicle front-rearward direction relative to the front side member at the time of the short overlap collision, the closed-section portion collides with the suspension tower. Hereby, a front collision load is transmitted to the suspension tower via the closed-section portion of the wheel house.

According to the vehicle-body front structure, the front collision load is transmitted to the suspension tower, thereby making it possible to further improve the collision performance with respect to the short overlap collision.

In the vehicle-body front structure, the wheel house may form the closed-section portion and the wheel house may include a pair of a wheel-house lower and a wheel-house upper divided in the vehicle up-down direction, and the wheel-house upper may be formed integrally with the suspension tower.

According to the vehicle-body front structure, the closed-section portion is constituted by the wheel-house upper and the wheel-house lower. The wheel-house upper is formed integrally with the suspension tower. This improves transmission efficiency of the front collision load transmitted from the closed-section portion to the suspension tower at the time of the short overlap collision.

According to the vehicle-body front structure, it is possible to efficiently transmit the front collision load from the closed-section portion to the suspension tower at the time of the short overlap collision.

The vehicle-body front structure may include an apron upper member as a frame member constituting a frame of an upper side part of the vehicle-body front portion, an inner end part of the apron upper member in the vehicle width direction may be connected to a front part of the front side member, and the apron upper member may be formed integrally with the suspension tower.

According to the vehicle-body front structure, the front collision load is dispersedly transmitted to the front side member and the apron upper member via the wheel house. This accordingly restrains deformation of a cabin (not shown), thereby improving the collision performance with respect to the short overlap collision.

In the vehicle-body front structure, the closed-section portion may be provided with front-rear bead portions extending in the vehicle front-rearward direction.

According to the vehicle-body front structure, the closed-section portion is provided with the front-rear bead portions extending in the vehicle front-rearward direction, thereby further increasing the rigidity of the closed-section portion in the vehicle front-rearward direction.

According to the vehicle-body front structure, it is possible to increase the rigidity of the closed-section portion in the vehicle front-rearward direction with a simple structure.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view illustrating a vehicle-body front portion to which a vehicle-body front structure according to a first embodiment of the present invention is applied;

FIG. 2 is a plane view illustrating the vehicle-body front portion illustrated in FIG. 1;

FIG. 3 is an enlarged sectional view taken along a line 3-3 in FIG. 2;

FIG. 4 is a plane view corresponding to FIG. 2 and illustrates an example of a collision state at the time of a short overlap collision;

FIG. 5 is a perspective view illustrating a vehicle-body front portion to which a vehicle-body front structure according to a second embodiment of the present invention is applied;

FIG. 6 is a plane view illustrating the vehicle-body front portion illustrated in FIG. 5; and

FIG. 7 is an enlarged sectional view taken along a line 7-7 in FIG. 6.

### DETAILED DESCRIPTION OF EMBODIMENTS

The following describes a vehicle-body front structure according to one embodiment of the present invention with reference to the drawings. Note that an arrow UP shown appropriately in each figure indicates an upper side in a vehicle up-down direction, an arrow FR indicates a front side in a vehicle front-rearward direction, and an arrow OUT indicates an outer side (a vehicle-body right side) in a vehicle width direction.

Initially described is a first embodiment.

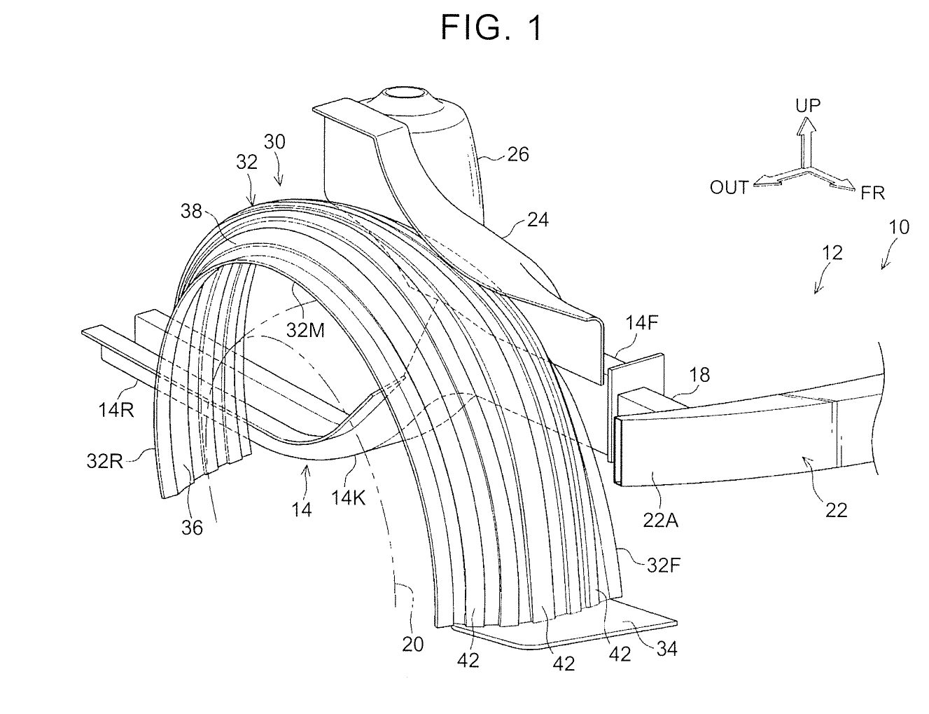

FIG. 1 illustrates a vehicle-body front portion 12 to which a vehicle-body front structure 10 according to the first embodiment is applied. The vehicle-body front structure 10 includes paired front side members 14, a front bumper reinforcement 22, an apron upper member 24, and a wheel house 30. Note that the vehicle-body front portion 12 is configured in a bilaterally symmetrical manner about a central portion of the vehicle-body front portion 12 in the vehicle width direction. In view of this, the following deals with a configuration of a right half of the vehicle-body front structure 10, and a configuration of a left half of the vehicle-body front structure 10 is not described.

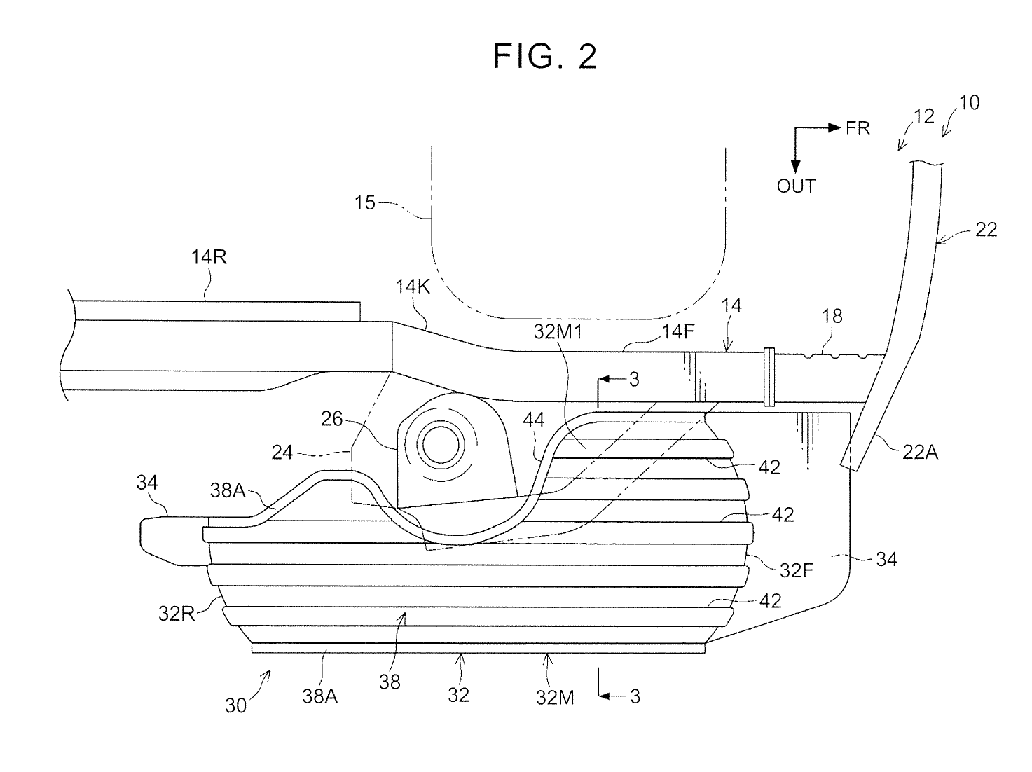

The paired front side members 14 are placed at respective sides of the vehicle-body front portion 12 in the vehicle width direction. The paired front side members 14 are frame members constituting frames of side parts of the vehicle-body front portion 12, and are arranged at respective sides, in the vehicle width direction, of a power unit 15 (see FIG. 2) provided as a drive source in the vehicle-body front portion 12.

Each of the front side members 14 extends in the vehicle front-rearward direction, and has a closed-shaped section when viewed from the vehicle front-rearward direction. Further, a rear part 14R of the front side member 14 in the vehicle front-rearward direction is placed at a lower side in the vehicle up-down direction relative to a front part 14F thereof in the vehicle front-rearward direction. The front part 14F and the rear part 14R of the front side member 14 are connected via a kick part 14K inclined from the front part 14F toward a rear side in the vehicle front-rearward direction and the lower side in the vehicle up-down direction. Further, a front end part of the front side member 14 in the vehicle front-rearward direction is provided with a tubular crash box 18 configured to absorb a collision energy by being compressively deformed in an axial direction at the time of a front end collision.

The power unit 15 is, for example, a drive source configured to rotationally drive a front wheel 20 arranged at an outer side of the front side member 14 in the vehicle width direction, and is configured to include at least one of an engine as an internal combustion engine and an electric motor. The power unit 15 is supported by the paired front side members 14 via a mounting bracket (not shown). Note that a cabin (a passenger room) (not shown) is formed at a rear side of the power unit in the vehicle front-rearward direction across a dash panel.

At front sides of the paired front side members 14 in the vehicle front-rearward direction, a front bumper reinforcement (hereinafter, just referred to as “bumper reinforcement”) 22 is arranged. The bumper reinforcement 22 is arranged at a front end side of the vehicle-body front portion 12 so as to extend in the vehicle width direction and to have a generally rectangular closed-shaped section when viewed from the vehicle width direction. Respective front end parts of the paired front side members 14 are connected to respective sides of the bumper reinforcement 22 in the vehicle width direction via the crash boxes 18 described above. Further, an end part 22A of the bumper reinforcement 22 in the vehicle width direction extends outwardly relative to the front side member 14 in the vehicle width direction.

The apron upper member 24 is arranged at the outer side of the front side member 14 in the vehicle width direction and at the upper side thereof in the vehicle up-down direction. The apron upper member 24 is a frame member constituting a frame of an upper side part of the vehicle-body front portion 12. The apron upper member 24 extends along the front side member 14 in the vehicle front-rearward direction, and its rear end part is connected to a front pillar (not shown). An inner end part of the apron upper member 24 in the vehicle width direction is connected to the front part 14F of the front side member 14. Further, a suspension tower 26 is formed integrally with the apron upper member 24.

The suspension tower 26 supports an upper end part of a suspension (not shown) that supports the front wheel 20, and has a rigidity and a strength that allow the suspension tower 26 to support the suspension. The suspension tower 26 is placed between the apron upper member 24 and the front side member 14 in a plane view, and an inner end part thereof in the vehicle width direction is connected to the front part 14F of the front side member 14.

The wheel house 30 is arranged at the outer side of the front side member 14 in the vehicle width direction and at the upper side of the front wheel 20 in the vehicle up-down direction. The wheel house 30 includes a wheel-house body portion 32 covering an upper part of the front wheel 20 from the upper side in the vehicle up-down direction, and paired flange portions 34 attached to a vehicle body. Note that a rocker (not shown) is arranged at a rear side of the wheel house 30 in the vehicle front-rearward direction along the vehicle front-rearward direction, and the rocker constitutes a frame of a vehicle-body side portion.

The wheel-house body portion 32 curves along a circumferential direction of the front wheel 20 so as to form a projection upward in the vehicle up-down direction. The wheel-house body portion 32 is connected to the front part 14F of the front side member 14 and the apron upper member 24 via a bracket or the like (not shown). Further, as illustrated in FIG. 2, the paired flange portions 34 are provided at respective ends of the wheel-house body portion 32 in the vehicle front-rearward direction, and the wheel house 30 is attached to a vehicle-body bottom portion (not shown) via the flange portions 34.

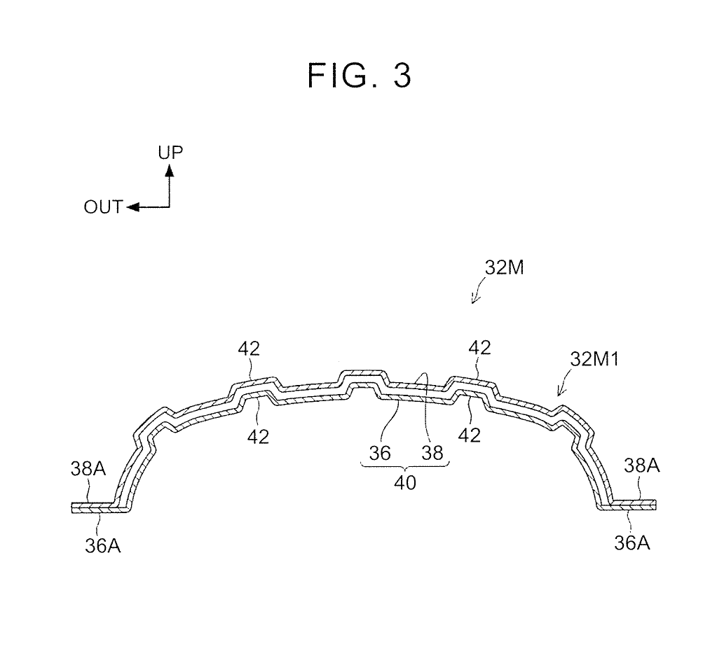

As illustrated in FIG. 3, the wheel-house body portion 32 includes a pair of a wheel-house lower 36 and a wheel-house upper 38 divided in the vehicle up-down direction. The wheel-house lower 36 and the wheel-house upper 38 are each formed from a steel sheet to be curved gently so that an intermediate part thereof in the vehicle width direction forms a projection upwardly in the vehicle up-down direction.

The wheel-house lower 36 is connected to the wheel-house upper 38 at flange portions 36A, 38A provided at respective ends thereof in the vehicle width direction. The wheel-house lower 36 and the wheel-house upper 38 form a closed-section portion 40 having a closed-shaped section when viewed from the vehicle front-rearward direction.

The closed-section portion 40 is formed over a generally overall length of the wheel-house body portion 32 in the vehicle front-rearward direction. That is, the closed-section portion 40 is formed over the front end part 32F, the intermediate part 32M, and the rear end part 32R of the wheel-house body portion 32 in the vehicle front-rearward direction, and the closed-section portion 40 curves along the circumferential direction of the front wheel 20. Accordingly, a section of the closed-section portion 40 taken along a radial direction of the front wheel 20 is oriented in the vehicle front-rearward direction at the intermediate part (a top) 32M of the wheel-house body portion 32, and is inclined so as to be oriented in the vehicle up-down direction as it goes toward the front end part 32F or the rear end part 32R from the intermediate part 32M.

Hereby, the closed-section portion 40 contributes to a rigidity in the vehicle front-rearward direction at the intermediate part 32M of the wheel-house body portion 32. However, the rigidity decreases from the intermediate part 32M toward the front end part 32F or the rear end part 32R, so that the wheel-house body portion 32 tends to crushes easily at that part. That is, the front end part 32F and the rear end part 32R of the wheel-house body portion 32 are configured to function as energy absorption portions that absorb an energy such that the front end part 32F and the rear end part 32R crush due to a front collision load in the vehicle front-rearward direction.

Further, the closed-section portion 40 is reinforced by a plurality of front-rear bead portions 42. More specifically, the plurality of front-rear bead portions 42 each forming a projection upward in the vehicle up-down direction is provided in intermediate parts of the wheel-house lower 36 and the wheel-house upper 38 in the vehicle width direction. The plurality of front-rear bead portions 42 extends in the vehicle front-rearward direction along each of the wheel-house lower 36 and the wheel-house upper 38, and is formed at intervals in the vehicle width direction. The front-rear bead portions 42 further increase the rigidity of the intermediate part 32M of the wheel-house body portion 32 in the vehicle front-rearward direction.

As illustrated in FIG. 2, a recessed portion 44 that is recessed outwardly in the vehicle width direction is formed in the inner end part of the intermediate part 32M of the wheel-house body portion 32 in the vehicle width direction. The suspension tower 26 described above is arranged in the recessed portion 44. The recessed portion 44 surrounds an outer side of the suspension tower 26 in the vehicle width direction, and a front end part thereof in the vehicle front-rearward direction comes around a front side of the suspension tower 26 in the vehicle front-rearward direction.

Further, a load transmission portion 32M1 for transmitting a front collision load to the suspension tower 26 is provided at a front side of the recessed portion 44 in the vehicle front-rearward direction in the intermediate part 32M of the wheel-house body portion 32. That is, a part of the closed-section portion 40 constituting the intermediate part 32M of the wheel-house body portion 32 is placed at the front side of the suspension tower 26 in the vehicle front-rearward direction. The load transmission portion 32M1 is provided with the front-rear bead portion 42 described above. The load transmission portion 32M1 collides with the suspension tower 26 along with a short overlap collision, thereby transmitting a front collision load to the suspension tower 26.

Next will be described an interaction of the first embodiment.

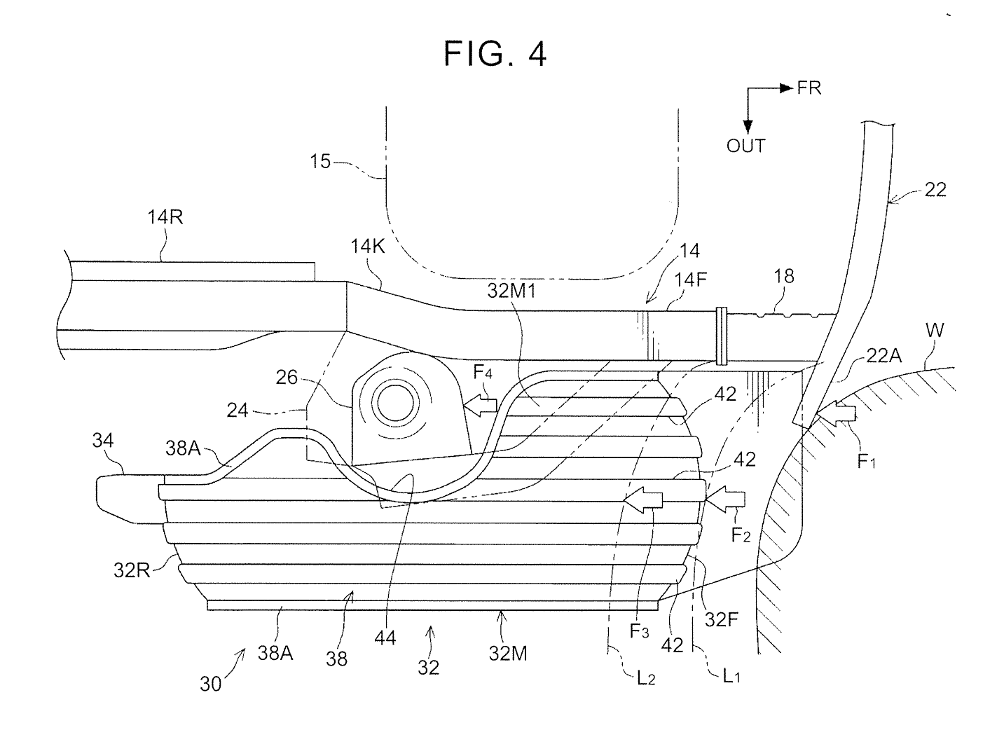

As illustrated in FIG. 4, at the time of a short overlap collision in which a vehicle front collision occurs at an outer side relative to the front side member 14 in the vehicle width direction, a collision object W collides with the end part 22A of the bumper reinforcement 22. Hereby, a front collision load F₁ directed rearward in the vehicle front-rearward direction is input into the crash box 18 via the bumper reinforcement 22, so that the crash box 18 is compressively deformed in its axial direction. Hereby, a collision energy is absorbed.

Then, when the collision object W further moves rearward in the vehicle front-rearward direction relative to the vehicle-body front portion 12 as illustrated by an alternate long and two short dashes line L₁, the collision object W collides with the front end part 32F of the wheel-house body portion 32, so that a front collision load F₂ directed rearward in the vehicle front-rearward direction is input into the front end part 32F.

Here, the wheel-house body portion 32 includes the closed-section portion 40 (see FIG. 3) over the overall length thereof in the vehicle front-rearward direction. The closed-section portion 40 contributes to the rigidity in the vehicle front-rearward direction at the intermediate part 32M of the wheel-house body portion 32. However, the rigidity in the vehicle front-rearward direction decreases from the intermediate part 32M toward the front end part 32F or the rear end part 32R, so that the wheel-house body portion 32 tends to crushe easily at that part. Accordingly, when the front collision load F₂ is input into the front end part 32F of the wheel-house body portion 32, the front end part 32F crushes in the vehicle front-rearward direction in a space between the wheel-house body portion 32 and the front wheel 20, for example. Hereby, the collision energy is absorbed.

Then, when the collision object W further relatively moves rearward in the vehicle front-rearward direction while crushing the front end part 32F of the wheel-house body portion 32, and the collision object W reaches the intermediate part 32M of the wheel-house body portion 32 as illustrated by an alternate long and two short dashes line L₂, a front collision load F₃ directed rearward in the vehicle front-rearward direction is input into the intermediate part 32M.

Here, the rigidity in the vehicle front-rearward direction is increased at the intermediate part 32M of the wheel-house body portion 32 due to the closed-section portion 40, as described above. Further, the closed-section portion 40 is provided with the plurality of front-rear bead portions 42, so that the rigidity in the vehicle front-rearward direction is increased due to the front-rear bead portions 42. Accordingly, when the collision object W collides with the intermediate part 32M of the wheel-house body portion 32, the front collision load F₃ is dispersedly transmitted to the front side member 14 and the apron upper member 24 via the intermediate part 32M.

Further, when the wheel-house body portion 32 moves rearward in the vehicle front-rearward direction relative to the front side member 14 along with the collision with the collision object W, the load transmission portion 32M1 provided in the intermediate part 32M of the wheel-house body portion 32 collides with the suspension tower 26. Hereby, a front collision load F₄ is dispersedly transmitted to the front side member 14 and the apron upper member 24 via the high-strength suspension tower 26.

Further, when the wheel-house body portion 32 moves rearward in the vehicle front-rearward direction relative to the front side member 14 and then the rear end part 32R of the wheel-house body portion 32 collides with the rocker (not shown), the rear end part 32R crushes. Hereby, the collision energy is absorbed.

As such, in the present embodiment, the collision energy is absorbed by the front end part 32F and the rear end part 32R of the wheel-house body portion 32, and the front collision load F₃ is dispersedly transmitted to the front side member 14 and the apron upper member 24 via the intermediate part 32M of the wheel-house body portion 32. This accordingly restrains deformation of the cabin (not shown), thereby improving collision performance with respect to the short overlap collision.

Further, the front-rear bead portions 42 are provided in the intermediate part 32M of the wheel-house body portion 32 so as to increase the rigidity of the intermediate part 32M of the wheel-house body portion 32 in the vehicle front-rearward direction. This makes it possible to increase transmission efficiency of the front collision load F₃ transmitted to the front side member 14 and so on.

Further, the load transmission portion 32M1 is provided in the intermediate part 32M of the wheel-house body portion 32, thereby making it possible to dispersedly transmit the front collision load F₄ to the front side member 14 and so on via the high-strength suspension tower 26.

Besides, the present embodiment is configured such that the closed-section portion 40 increases the rigidity in the vehicle front-rearward direction at the intermediate part 32M of the wheel-house body portion 32 and the front collision load F₃ is transmitted rearward in the vehicle front-rearward direction by the intermediate part 32M. In view of this, it is not necessary to provide a new member at the outer side of the front side member 14 in the vehicle width direction. This accordingly makes it possible to restrain an increase of the number of components.

Next will be described a second embodiment. Note that a constituent having the same configuration as in the first embodiment has the same reference sign as in the first embodiment, and its description is omitted appropriately.

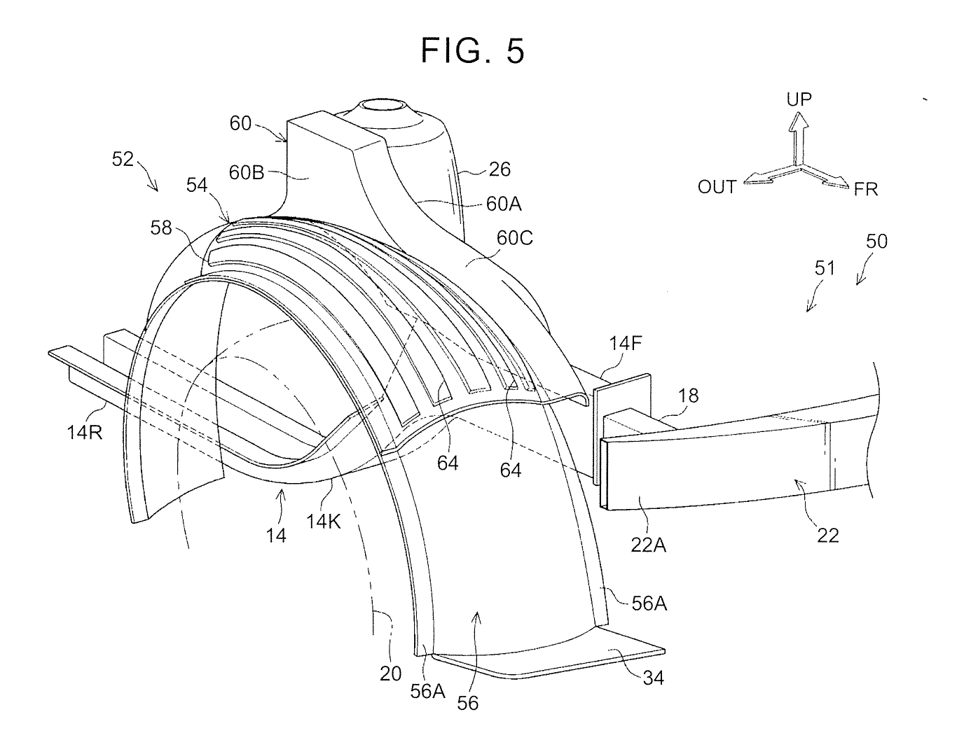

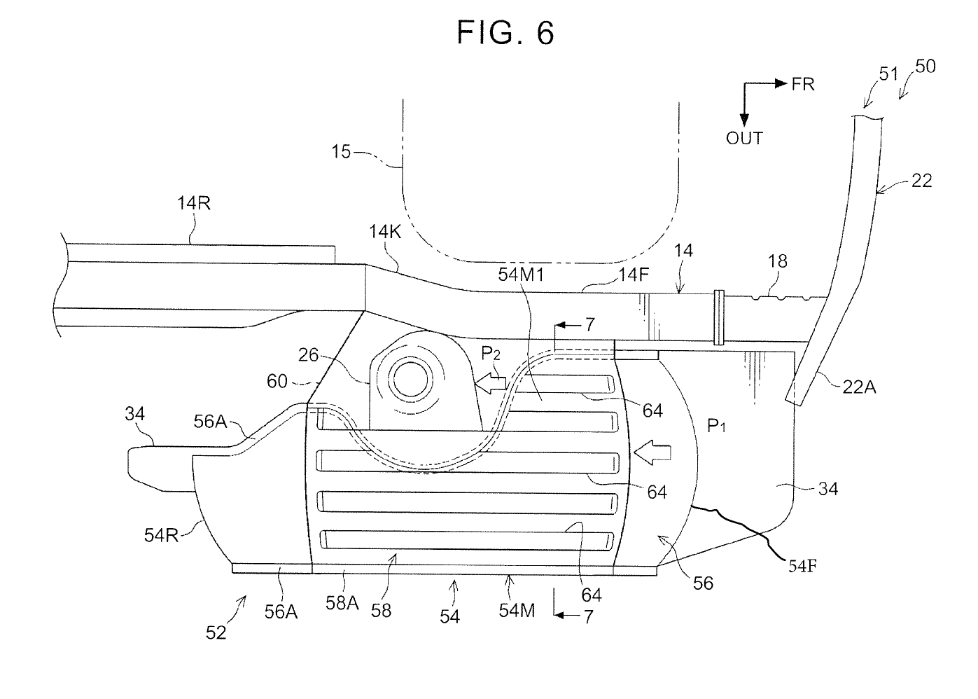

FIGS. 5 and 6 illustrate a vehicle-body front portion 51 to which a vehicle-body front structure 50 according to the second embodiment is applied. A wheel house 52 of the vehicle-body front structure 50 includes a wheel-house body portion 54 and paired flange portions 34. The wheel-house body portion 54 includes a wheel-house lower 56 and a wheel-house upper 58 divided in the vehicle up-down direction. The front-rear bead portions 42, which are provided in the wheel-house lower 36 (see FIG. 3) in the first embodiment, is omitted from the wheel-house lower 56. Note that the front-rear bead portions 42 may be provided in the wheel-house lower 56.

The wheel-house upper 58 is formed integrally with a suspension tower 26 via an apron upper member 60. More specifically, the apron upper member 60 includes: a pair of an inner wall portion 60A and an outer wall portion 60B opposed to each other in the vehicle width direction; and an upper wall portion 60C configured to connect upper end parts of the inner wall portion 60A and the outer wall portion 60B. The suspension tower 26 is formed integrally with the inner wall portion 60A of the apron upper member 60, and the wheel-house upper 58 is formed integrally with the outer wall portion 60B of the apron upper member 60.

The wheel-house upper 58 extends outwardly in the vehicle width direction from a lower end part of the outer wall portion 60B of the apron upper member 60, and is put on an intermediate part (a top) of the wheel-house lower 56 in the vehicle front-rearward direction. An intermediate part 54M of the wheel-house body portion 54 is constituted by the wheel-house upper 58 and the wheel-house lower 56. Note that a front end part 54F of the wheel-house body portion 54 is constituted by a front end part of the wheel-house lower 56, and a rear end part 54R of the wheel-house body portion 54 is constituted by a rear end part of the wheel-house lower 56.

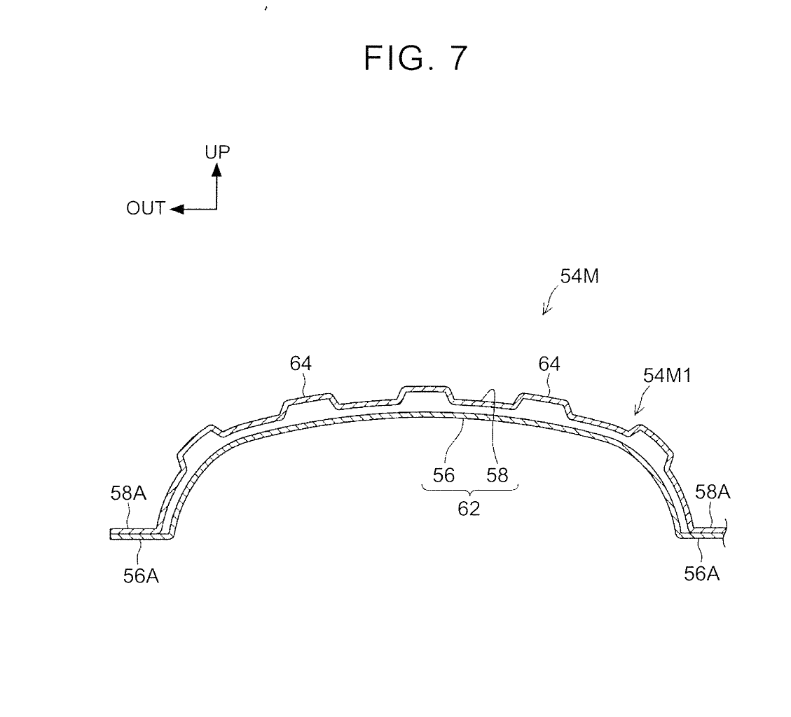

As illustrated in FIG. 7, the wheel-house lower 56 is connected to the wheel-house upper 58 at flange portions 56A, 58A provided at respective ends thereof in the vehicle width direction. The wheel-house lower 56 and the wheel-house upper 58 form, in the intermediate part 54M of the wheel-house body portion 54, a closed-section portion 62 having a closed-shaped section when viewed from the vehicle front-rearward direction.

Further, a plurality of front-rear bead portions 64 extending in the vehicle front-rearward direction is formed in the wheel-house upper 58. A rigidity of the closed-section portion 62 in the vehicle front-rearward direction is increased due to the front-rear bead portions 64. Further, as illustrated in FIG. 6, the intermediate part 54M of the wheel-house body portion 54 is provided with a load transmission portion 54M1 placed at a front side of the suspension tower 26 in the vehicle front-rearward direction.

Next will be described an interaction of the second embodiment.

In the second embodiment, the closed-section portion 62 is formed in the intermediate part 54M of the wheel house 52. The wheel-house upper 58 constituting the closed-section portion 62 is formed integrally with the suspension tower 26 via the apron upper member 60.

Accordingly, as illustrated in FIG. 6, when a front collision load P_{I} is input into the intermediate part 54M of the wheel house 52 at the time of a short overlap collision, the front collision load P₁ is transmitted to the high-strength suspension tower 26 via the apron upper member 60.

Further, when the wheel-house body portion 54 moves rearward in the vehicle front-rearward direction relative to the front side member 14 along with the short overlap collision, the load transmission portion 54M1 provided in the intermediate part 54M of the wheel-house body portion 54 collides with the suspension tower 26. Hereby, a front collision load P₂ is dispersedly transmitted to the front side member 14 and the apron upper member 60 via the high-strength suspension tower 26.

When the wheel-house upper 58 constituting the closed-section portion 62 is formed integrally with the suspension tower 26 as such, it is possible to efficiently transmit the front collision loads P₁, P₂ to the suspension tower 26 at the time of the short overlap collision. This accordingly improves collision performance with respect to the short overlap collision.

Next will be described modified embodiments of the first, second embodiments. The following describes various modified embodiments of the first embodiment, but these modified embodiments are applicable to the second embodiment appropriately.

The first embodiment deals with an example in which the closed-section portion 40 is provided over a generally overall length of the wheel-house body portion 32 in the vehicle front-rearward direction. However, the closed-section portion 40 may be provided at least in the intermediate part 32M of the wheel-house body portion 32. Further, for example, only the load transmission portion 32M1 placed at the front side of the suspension tower 26 in the vehicle front-rearward direction may be formed into a closed-section portion. Note that the load transmission portion 32M1 may be provided as needed, and is omissible appropriately.

Further, the first embodiment deals with an example in which the front-rear bead portions 42 are provided in the closed-section portion 40, but the present invention is not limited to this. For example, a reinforcing member such as a bulk head may be provided inside the closed-section portion 40, so as to increase the rigidity of the closed-section portion 40 in the vehicle front-rearward direction. Further, the front-rear bead portions 42 can be omitted.

Further, the first embodiment deals with an example in which the wheel-house body portion 32 is formed from a steel sheet, but the present invention is not limited to this. For example, the wheel-house body portion 32 may be formed from resin or the like.

Further, the first embodiment may be applied to at least one of the right and left wheel houses 30. For example, the first embodiment may be applied to only the wheel house 30 on a driver side. In addition to that, the first embodiment deals with an example in which the vehicle-body front portion 12 is configured in a bilaterally symmetrical manner about the central portion of the vehicle width direction, but the vehicle-body front portion 12 may be configured in a bilaterally asymmetrical manner about the central portion of the vehicle width direction.

Embodiments of the present invention have been explained as above, but it should be understood that the present invention is not limited to these embodiments, and the embodiments and various modified embodiments may be employed in combination appropriately or the present invention may be performable in various aspects without departing from the gist of the present invention.

What is claimed is:

1. A vehicle-body front structure comprising:
a front side member arranged at a side part of a vehicle-body front portion so as to extend in a vehicle front-rearward direction, and configured such that a front wheel is arranged at an outer side of the front side member in a vehicle width direction; and
a wheel house covering the front wheel from an upper side in a vehicle up-down direction, curved along a circumferential direction of the front wheel, and including a closed-section portion having a closed-shaped section when viewed from the vehicle front-rearward direction, the closed-section portion being formed at least in an intermediate part of the wheel house in the vehicle front-rearward direction.

2. The vehicle-body front structure according to claim 1, further comprising:
a suspension tower arranged at the outer side of the front side member in the vehicle width direction, and configured to support an upper end part of a suspension that supports the front wheel, wherein:
at least part of the closed-section portion is placed at a front side of the suspension tower in the vehicle front-rearward direction.

3. The vehicle-body front structure according to claim 2, wherein:
the wheel house forms the closed-section portion, and the wheel house includes a pair of a wheel-house lower and a wheel-house upper divided in the vehicle up-down direction; and
the wheel-house upper is formed integrally with the suspension tower.

4. The vehicle-body front structure according to claim 2, further comprising:
an apron upper member as a frame member constituting a frame of an upper side part of the vehicle-body front portion, wherein:
an inner end part of the apron upper member in the vehicle width direction is connected to a front part of the front side member; and
the apron upper member is formed integrally with the suspension tower.

5. The vehicle-body front structure according to claim 1, wherein:
the closed-section portion is provided with front-rear bead portions extending in the vehicle front-rearward direction.
